(19) United States
(12) Patent Application Publication
(10) Pub. No.: US 2026/0081043 A1
(43) Pub. Date: Mar. 19, 2026

(54) NON-LIQUID MANUFACTURE FOR URANIUM BEARING KERNEL

(71) Applicant: Westinghouse Electric Company LLC, Cranberry Township, PA (US)

(72) Inventor: Edward J. Lahoda, Edgewood, PA (US)

(73) Assignee: Westinghouse Electric Company LLC, Cranberry Township, PA (US)

(21) Appl. No.: 18/827,701

(22) Filed: Sep. 7, 2024

(51) Int. Cl. G21C 3/62; G21C 3/04; G21C 21/04

(52) U.S. Cl. CPC G21C 3/623; G21C 3/048; G21C 21/04

(57) ABSTRACT

A method for producing a fuel kernel is provided. The method comprises producing a dry fissile material comprising enriched uranium, forming a particle from the dry fissile material, the particle having a diameter of 1 millimeter or less; and thermally processing the particle to produce the fuel kernel. A press system for dry fissile material is also provided.

### BACKGROUND

TRi-structural ISOtropic (TRISO) fuels are particle-based fuels which contain uranium-bearing kernels surrounded by various layers. The overall density of uranium in TRISO particles may be limited. Some methods for manufacturing kernels may compensate for low overall uranium density to produce TRISO fuels having suitable burnup levels by incorporating solutions of dissolved uranium having high enrichment levels, which may exacerbate issues associated with safety and security. Accordingly, a need exists for alternative non-liquid manufacturing methods for uranium-bearing kernels.

### SUMMARY

The following summary is provided to facilitate an understanding of some of the innovative features unique to the aspects disclosed herein and is not intended to be a full description. A full appreciation of the various aspects disclosed herein can be gained by taking the entire specification, claims, and abstract as a whole.

In various aspects, a method for producing a fuel kernel is disclosed. In some aspects, the method includes producing a dry fissile, forming a particle from the dry fissile material, and thermally processing the particle to produce the fuel kernel. In certain aspects, the dry fissile material includes enriched uranium. In some aspects, the particle has a diameter of 1 millimeter or less.

In various aspects, a press system for dry fissile material is disclosed. In some aspects, the press system includes first tooling and second tooling, the first tooling including a first forming surface and the second tooling including a second forming surface. In certain aspects, the first tooling and the second tooling are configured to transition the first forming surface and the second forming surface from a first configuration for receiving an amount of dry fissile material for forming a bead between the first forming surface and the second forming surface, the bead having dimensions suitable for forming a fuel kernel, and a second configuration that yields the bead.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 illustrates a perspective view of a microreactor core, according to at least one non-limiting aspect of the present disclosure.

FIG. 2 illustrates a cross-section view of a fuel compact according to at least one non-limiting aspect of the present disclosure.

FIG. 3 illustrates a flow diagram of a method, according to at least one non-limiting aspect of the present disclosure.

FIG. 4 provides a perspective view of a bead, in accordance with at least one non-limiting aspect of the present disclosure.

FIG. 5 provides a cross-section view of the bead of FIG. 3, in accordance with at least one non-limiting aspect of the present disclosure.

FIG. 6 is a cross-sectional schematic representation of a press system, in accordance with at least one non-limiting aspect of the present disclosure.

FIG. 7A is a cross-sectional schematic representation of a press system, in accordance with at least one non-limiting aspect of the present disclosure.

FIG. 7B is a cross-sectional schematic representation of a press system, in accordance with at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

In a fuel assembly of a nuclear reactor core, fissile fuels such as, for example, uranium-235 (sometimes referred to hereinafter as “U-235”) interact with an incident neutron flux and upon absorbing an appropriately energetic neutron, such as a thermal neutron, can subsequently fission into a number of lighter nuclei fission products and/or fragments, thereby generating an emission of prompt neutrons and an amount of heat. Fissile fuels having U-235 enrichments of 5% or less may be produced with wet processes such as the ammonium diuranate (ADU) and/or ammonium uranyl carbonate (AUC) based processes, which may include producing triuranium octoxide (U₃O₈) from both uranyl nitrate hexahydrate (UNH) and uranium hexafluoride (UF₆). Other example processes for fuel production are described in further detail in U.S. patent application Ser. No. 12/465,729, which is owned by the Applicant of the present disclosure, and which is herein incorporated by reference in its entirety.

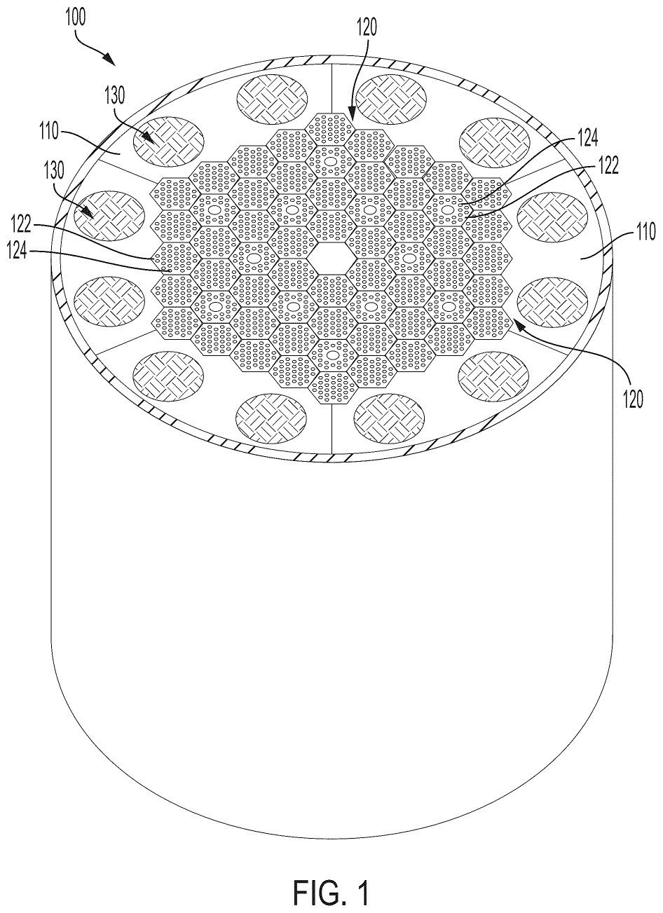

Advanced nuclear reactor designs, such as, for example, nuclear microreactors, employing smaller scale architectures than traditional PWRs, in both size and power output, are emerging as a solution for providing a reliable off-grid power source. For example, the eVinci™ microreactor currently being developed by Westinghouse is comprised of a microreactor vessel built into a dedicated container as an integral package. The space between the microreactor vessel and the container is minimized to provide a preassembled package having a footprint that is optimized for transportation via truck to a final destination. A perspective view of a microreactor vessel 100 cross-section is provided in FIG. 1, in accordance with at least one non-limiting aspect of the present disclosure. The reactor vessel 100 includes a core comprising a radial reflector 110, a fuel assembly 120, and control drums 130. The radial reflector 110 minimizes stray neutron leakage through the vessel 100. Generally, the fuel assembly 120 is operated at high temperatures of about 600° C. or greater and can include a structure based on unit cells 122 comprised of a solid material, such as graphite, in which fueled compacts 124 can be inserted. Each of the fueled compacts 124 includes fissile fuel that is able to tolerate the operating temperatures, such as TRISO fuel which can maintain good thermal conductivity with surrounding structures thereby facilitating heat transfer during operation. Thus, the microreactor vessel 100 can maximize the potential power output therefrom while maintaining a space saving geometry. Other example microreactors and operation methods thereof are described in further detail in U.S. patent application Ser. No. 17/084,365 and in U.S. patent application Ser. No. 18/057,208, each of which is owned by the Applicant of the present disclosure, and each of which is herein incorporated by reference in its entirety.

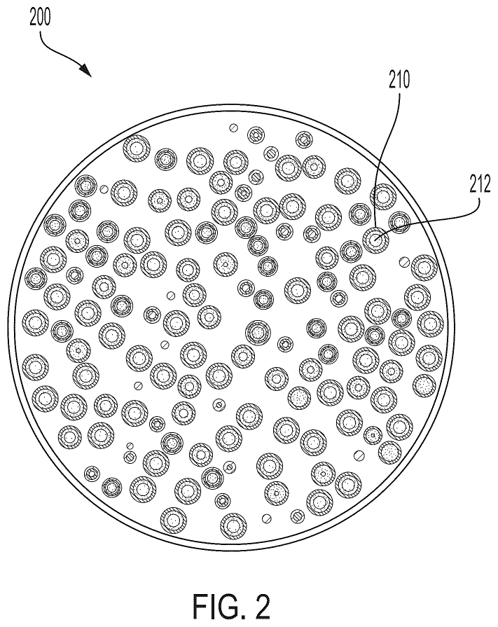

In the context of particle-based fuels, such as, for example, TRISO fuels, the fissile material can be in the form of a kernel, which may be encapsulated by additional materials. For example, FIG. 2 depicts a radial cross-section view of a composite fueled compact 200 including particles 210. At least a portion of the particles 210 can include a core of fissile fuel 212. The fissile fuel 212 can be based on particles of uranium oxycarbide (UCO) which comprise a mixture of oxides and carbides of uranium, such as UO₂ and UC₂. However, other oxides and/or carbides and/or nitrides may be present based on the method used for particle production.

TRISO particles generally contain low densities of uranium in comparison with other types of fissile fuels, such as fuels for PWRs. Conventional methods for producing fissile particles for TRISO particles generally rely on aqueous processes, such as, for example, a sol-gel process wherein a first stream of U₃O₈ dissolved in nitric acid, and a second stream comprised of urea, hexamethylenetriamine, water and carbon are mixed to form a solution which is subsequently aged to form a colloidal suspension of gel particles comprising carbon and UO₃. The gel particles are dried and thermally processed in a controlled chemically active atmosphere to convert the gel particle chemistry into the UCO-based fuel kernels. However, incorporating the carbon via thermal processing of the gel particles can result in incomplete conversion of the gel particle carbon content, which may comprise particle stability during operation via intraparticle species migration due to residual carbon present therein. Additionally, the incomplete conversion may compromise the final effective fuel density of the fuel kernels, which may affect the kernel's ability to retain fission products along with limiting the amount of fissile material available. Thus, fuel particles based on fuel kernels produced via aqueous processes may require additional safety considerations which may complicate reactor operation and/or limit the useful lifetime thereof.

Due to the relatively low uranium loading in TRISO fuels, fissile material thereof may require U-235 enrichments of up to 19.75% in order to maintain criticality during reactor operation. However, these elevated enrichment levels may require special considerations related to safety and security. For example, in order to prevent criticality issues during manufacture of fuel, vessels used in the wet TRISO manufacturing processes are generally kept to less than about 5.6 inches in diameter. Accordingly, scaling up TRISO fuel manufacture may rely on the use of many parallel processing lines, which may be cost-prohibitive. Additionally, the reliance on dissolved uranium may lead to insider threat security concerns due to the risk of diverted liquid streams. Moreover, treatment and release of liquid waste streams from conventional TRISO manufacturing may be hazardous, thereby present additional safety hazards both to operators during waste treatment and to the environment upon eventual release of treated waste.

As discussed hereinabove, current manufacture of TRISO particles may suffer from operational and logistical issues associated with cost, safety and security. Accordingly, various aspects of the present disclosure provide various methods and devices for managing safety and/or security concerns when manufacturing fissile particles such as fissile kernels for TRISO fuels.

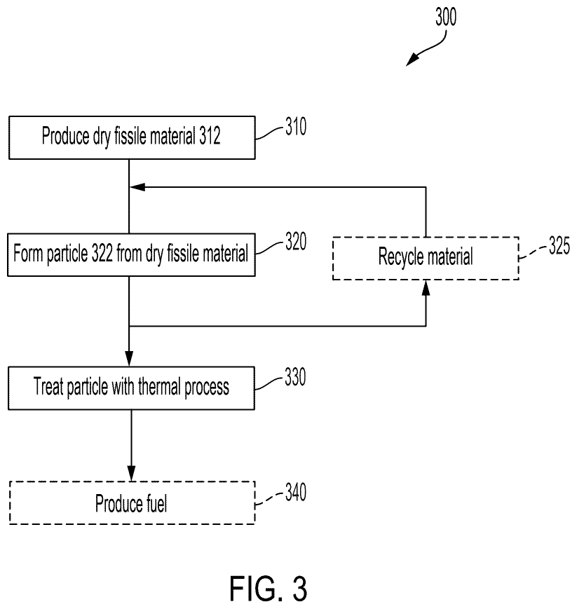

FIG. 3 depicts a method 300 for producing a fuel kernel according to at least one non-limiting aspect of the present disclosure. The method 300 includes producing 310 a dry fissile material 312 comprising enriched uranium, forming 320 a particle 322 from the dry fissile material 312, and thermally processing 330 the particle 322 to produce the fuel kernel 332. The particle 322 may be spherical, or substantially spherical, such that a diameter D_{P} thereof does not vary more than 5% from an average diameter. In various examples, the diameter D_{P} of the particle 322 may be the same as, or slightly larger than, the diameter DK of the fuel kernel 332. In some examples, the diameter D_{P} is about 1 millimeter (mm) or less. For example, a particle 322 having a diameter D_{P} of about 1 mm may vary in diameter in a range of 0.9 mm to 1.1 mm with an average thereof being 1 mm+/−0.05 mm. In certain examples, the diameter D_{P} is in a range of about 0.5 mm to about 1 mm.

As used herein, the term “dry process” and like may refer to a non-aqueous process and/or a process which is substantially free of solvents or substantial amounts of fissile material, or any radioactive precursors thereof, which are dissolved in liquids. In some examples, water may be present in dry processes in a non-liquid form, such as a superheated steam/vapor.

The dry fissile material 312 can include oxides, carbides and/or nitrides of uranium, such as, for example, UO₂, UCO, and UN. The dry fissile material can be produced with a dry process, which may include reacting UO₂ and/or uranyl fluoride (UO₂F₂) with a carbon containing compound, such as a hydrocarbon compound. Thus, carbon may be incorporated into the dry fissile material 312 prior to particle formation. Accordingly, in some aspects, the method 300 may produce fuel kernels which

The dry process may optionally include reacting uranium hexafluoride with steam to produce the UO₂F₂ at a temperature in a range of 600° C. to 800° C. The hydrocarbon compound can include a volatile hydrocarbon, and may include methane. UC may be produced in an inert environment, such as under a very low O₂, or substantially oxygen free, argon blanket, through either of reactions (I) and/or (II), at temperatures of at a temperature of about 1450° C., as shown below.

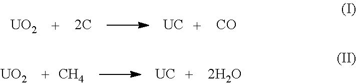

Alternatively, or additionally, the dry process can include producing UN under similar reaction conditions through either of reactions (III) and/or (IV), and followed by reaction (V) at a temperature of about 1800° C. under vacuum, as shown below.

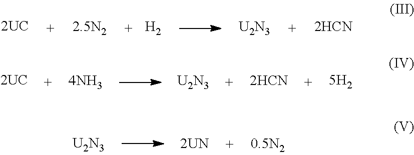

In some aspects, producing the dry fissile material as described above prior to particle formation can produce fuel kernels having high burnup with low species migration therein when incorporated into TRISO fuel particles.

In various examples, forming 320 the particle 322 can include forming a bead from the dry fissile material with a pelletizing process, which may be a dry process. The pelletizing process can be configured to produce beads having high green densities, such as by utilizing progressive pelletization to obtain a bead having a bulk density of at least 90%, or at least 95%. For example, an amount of the dry fissile material may undergo a succession of mechanical compressions in a pelletizing apparatus, such as with a die set of a press system or a rotary pelleting press, which may progressively increase the bulk density and/or decrease the bulk volume of beads, until the formed bead has a suitable green density and/or overall size for further processing. Additional dry fissile material may be added between successive compressions to ensure that the final bead is substantially free of any large voids therein. The produced bead may have a geometry suitable for a pressing operation, such as a spherical or a cylindrical geometry. Other configurations are contemplated by the present disclosure. For example, in other implementations, the bead may have a cuboid or other prismatic geometry. Beads may be formed in parallel by utilizing a press system having an array of dies, each of which may be separately used to compress dry fissile material with one compression event. Thus, utilizing a dry mechanical process for forming the beads may facilitate scale up of fuel kernel production while avoiding the cost, safety and security issues associated with scaling up liquid-based processes for producing fuel kernels.

In some aspects, as described in greater detail below, utilizing multiple compression stages may allow a separation of bead formation duties between different stages, such as utilizing an initial compression to gather an amount of material suitable for forming a bead and forming a rough compact therefrom with a high degree of confidence that enough material is present, and utilizing a subsequent compression to finalize the dimensions and packing density of the rough compact. The use of progressive pelletization may be especially beneficial when incorporated into a method for forming particles to be processed into fuel kernels due to the importance of particle size, geometry and packing density in the context of fuel performance and safety. Although progressive pelletizing is described herein in the context of two stages of compression, the present disclosure also envisions the use of any number of compressions.

The dimensions and/or geometry of the bead may be different from that of the desired particle 322 such that further processing is required to remove some of the compacted dry fissile material from the bead as residual and/or excess material. In certain examples, forming 320 the particle 322 can include mechanically reducing the size and/or geometry of the bead, which may include tumbling and/or grinding the bead in an apparatus such as a ball mill until the particle 322 is formed. Any residual dry fissile material from forming the particle 322 may be recycled. For example, the method may optionally include collecting 325 residual dry fissile material and returning the residual material as an input to the forming process.

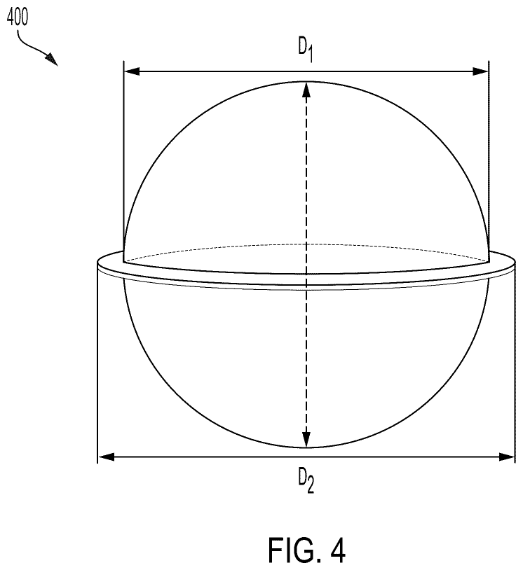

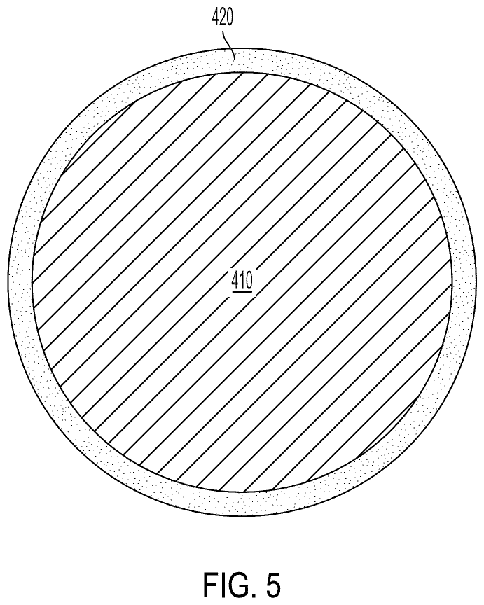

Now referring to FIG. 4, a perspective view of a bead 400 which may be formed with the pelletizing process discussed above is provided according to at least one non-limiting aspect of the present disclosure. FIG. 5 provides a cross-section view of the bead 400 of FIG. 4. In various examples, the bead 400 can include a central portion 410 having a diameter D_{B1}. Although the bead 400 is illustrated as having a spherical geometry, other configurations are contemplated. As used herein, the term diameter may refer to a cross-sectional diameter of an object having a spherical or ovoid geometry, or a diameter of a circle in which a cross-sectional geometry of an object is circumscribed. Thus, the bead 400 may have a non-spherical geometry. The diameter D_{B1} may be slightly greater than, or substantially equal to, the diameter D_{P}. In certain examples, the diameter D_{B1} is about 1.1 mm or less. In examples of the method 300 including mechanically reducing the size and/or geometry of the bead 400, the outer portion 420 may be removed and/or the central portion 410 may be reduced by mechanical reduction. While the outer portion 420 is depicted in FIGS. 4-5 as having an outer diameter D_{B2} for illustrative purposes, the outer portion 420 may be somewhat irregular. For example, the outer portion 420 may have an inner diameter corresponding to the diameter D_{B1} and an outer perimeter which may encompass any portion of an annular region defined by the diameters D_{B1} and D_{B2} without being defined by any particular profile, geometry, or thickness. In some examples, the diameter D_{B2} is greater than the diameter D_{B1} by about 0.2 mm or less, or about 0.1 mm.

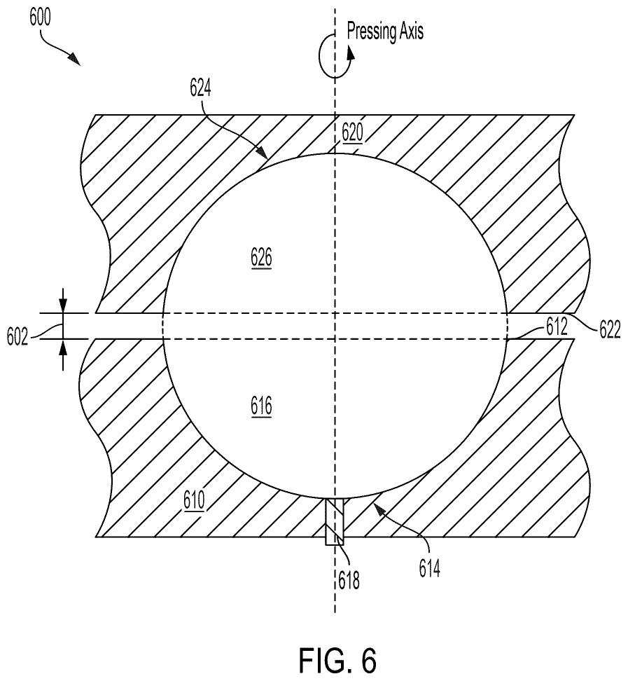

A compression of the dry fissile material, such as through pelletization, can involve enclosing the dry fissile material 312 between two forming surfaces which can enclose and/or compress at least a portion of the dry fissile material to form the central portion 410. For example, FIG. 6 provides a cross-section view of a press system 600 including a die 610, in accordance with at least one non-limiting aspect of the present disclosure. The die 610 includes a deck surface 612 and a forming surface 614 which forms a depression 616 with respect to a lateral plane defined by the deck surface 612. In certain examples, the die 610 may include a piston 618 having a first surface which sits flush with the forming surface 614 during compression and is movable into the depression region 616 following compression to eject any packed material.

The press system 600 can include additional tooling configured to compliment the die 610. For example, as illustrated in FIG. 6, the press system 600 can include a die 620 which includes a deck surface 622 and a forming surface 624 which forms a depression 626 with respect to a lateral plane defined by the deck surface 622. The die 620 is mounted such that the deck surfaces 612 and 622 are parallel with one another and the forming surfaces 614 and 624 are aligned with respect to a common pressing axis. In certain examples, the additional tooling may be mounted onto a movable piston centered to the pressing axis and the die 610 may be stationary such that the die 610 provides a counterforce against the tooling mounted to movable piston. Additionally, the dies may be incorporated into an array of dies to form multiple beads with a single compressive motion to facilitate production scaleup. For example, the die 610 may be one of many similarly configured dies on a first die array and the die 620 may be one of a plurality of similarly configured dies on a second die array opposing the first die array. Closing the first die array and the second die array onto one another can effect a plurality of compressions corresponding to the plurality of paired dies between the first and second die arrays.

Now referring to FIGS. 5-6, each of the two forming surfaces 614, 624 may have a hemispherical geometry that when drawn towards one another, the depressions 616, 626 form a spherical cavity having a diameter, such as, for example, a diameter equivalent to, or slightly greater than, the diameter D_{B1}. Alternatively, the dies may be configured to account for the formation of a bead with an outer portion, such as an outer portion 420 extending from central portion 410, as illustrated in FIG. 5. For example, the forming surfaces 614, 624 can be configured to have truncated hemispherical geometries which possess a radius of curvature corresponding to the diameter D_{B1}, with the corresponding deck surfaces being offset by gap 602 when the press system is closed, thereby effectively forming a compound cavity including the depressions 616, 626 and a planar region extending therefrom. When dry fissile material is disposed between these forming surfaces and the forming surfaces are brought together towards the closed position, any of the dry fissile material not incorporated into the spherical cavity may be pushed out into the planar region defined by the gap 602, thereby forming the outer portion 420 which may be referred to as a rim or a shoulder. Additional material added between the dies 610 and 620 may be further incorporated into the bead such that any void spaces in the bead resulting from previous compressions may be minimized and/or filled with dry fissile material. The gap 602 may correspond to an allowable thickness of outer portion 420, such as a thickness of about 0.1 mm or less.

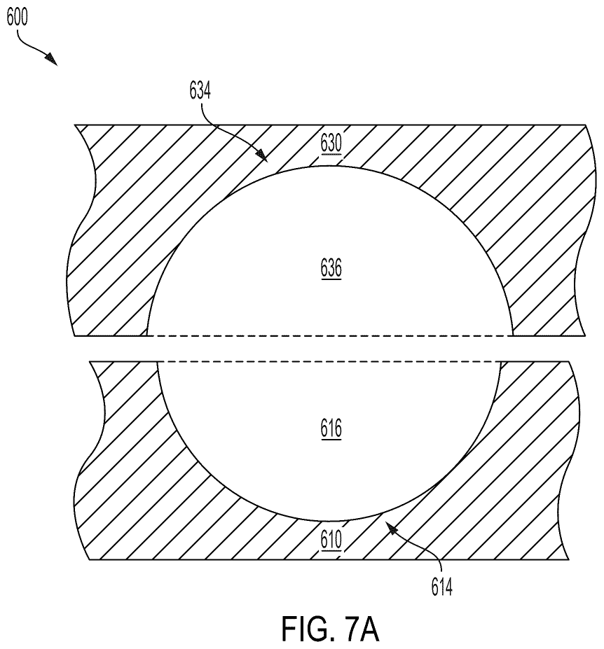

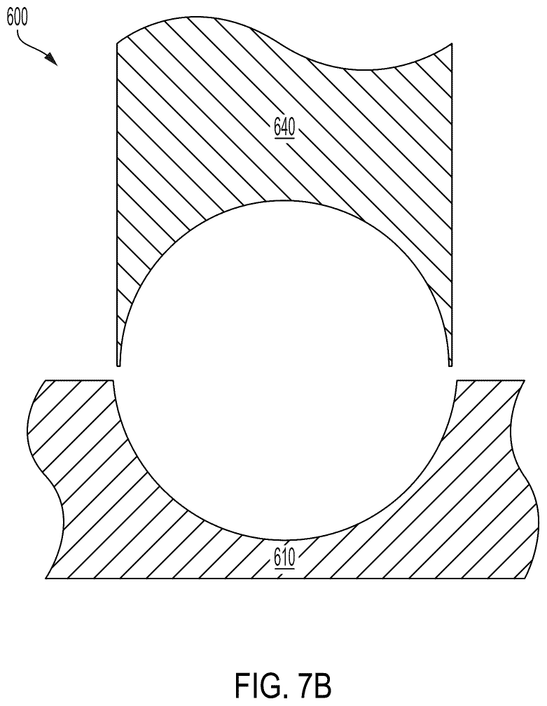

Alternatively, or additionally, the press system 600 may include additional tooling dissimilar with the die 610 and/or die 620. Now referring to FIGS. 7A and 7B, cross-sectional views of alternative tooling for the press system 600 including, respectively, a die 630 and a punch 640, are provided according to at least one non-limiting embodiment of the present disclosure. The die 630 is similar in many respects to the die 620 with the exception of having a different forming surface 634 and from the die 610 and/or the die 620. The punch 640 may have an outer diameter equal to, or slightly smaller than, the opening in the deck surface 612 defined by the forming surface such that any fissile material packed therebetween can be pressed to a final green density based on lowering at least a portion of the punch into the region associated with the depression 616.

The die 620, die 630, and/or punch 640 may be interchangeable with one another, such as by being mounted on a turret which also includes the first die. Thus, the press system may be configured to produce varying levels of compression on the dry fissile material disposed therein.

In examples where the press system 600 includes the die 630, the die 630 may be configured to be used prior to the die 620 in an initial compression to form an initial bead which may contain more dry fissile material than required to form the fuel kernel 332. For example, the die 630 may have a depression 636 slightly larger than depression 626 with respect to curvature. Thus, the die 630 and the die 610 may produce an initial bead including an oversized dome or cap of dry fissile material and the die 620 may reduce the size of the oversized portion. Introducing more dry fissile material into the press system than necessary to produce the final kernel and utilizing the die 630 to perform an initial compression may localize or position the dry fissile material for a subsequent compression, such that the subsequent compression may be relieved of performing the duty of positioning material in addition to compressing the material into a final size. Thus, the press system may be configured to decrease the likelihood of producing beads having any substantial void spaces therein. Accordingly, in some aspects, the press system may produce particles having consistent outer dimensions while also maintaining consistent levels of packing density thereof. Other embodiments are envisioned by the present disclosure. For example, in some implementations, the press system may include additional dies and/or punches which may vary in size and/or geometry to provide varying levels of compression.

Now referring back to FIG. 3, in various examples, thermally processing 330 the particle 322 can include sintering the particle, which may occur at temperatures in a range of about 1400° C. to about 2000° C. Since the particles 322 are produced without the use of liquids, the thermal processing thereof may yield kernels 332 having a high final density while maintaining the composition of the particles. Thus, in some aspects, the avoidance of utilizing wet processes in the method 300 may facilitate fine control of final kernel properties and/or chemistry, which may improve the performance thereof with respect to fission product containment and/or intraparticle species migration during operation. In some examples, the fuel kernel 332 may have a final bulk density of at least 97%, or at least 98% or at least 99%.

The method 300 may optionally include producing 340 fuel with the fuel kernel 332. For example, the fuel kernel 332 produced with the method 300 can be incorporated as a core into a fuel particle for a nuclear reactor, such as the TRISO fuel particle depicted in FIG. 2. Other embodiments are contemplated by the present disclosure. For example, in some implementations, a fuel kernel produced by the method 300 may be incorporated into a fuel pellet or a compact based thereon.

Various aspects of the present disclosure include, but are not limited to, the aspects listed in the following numbered clauses.

Clause 1—A method for producing a fuel kernel. The method comprises producing a dry fissile material, forming a particle from the dry fissile material and thermally processing the particle to produce the fuel kernel. The dry fissile material comprises enriched uranium and the particle has a diameter of 1 millimeter or less.

Clause 2—The method of clause 1, further comprising preparing the dry fissile material with a dry process.

Clause 3—The method of any one of clauses 1 or 2, wherein the dry fissile material comprises UCO.

Clause 4—The method of any one of clauses 2 or 3, wherein the dry process comprises reacting uranyl fluoride (UO₂F₂) with a hydrocarbon compound to produce the UCO.

Clause 5—The method of clause 4, wherein the hydrocarbon compound comprises a volatile hydrocarbon.

Clause 6—The method of any one of clauses 4 or 5, wherein the hydrocarbon compound comprises methane.

Clause 7—The method of any one of clauses 2-6, wherein the dry process comprises reacting uranium hexafluoride with steam to produce the UO₂F₂.

Clause 8—The method of any one of clauses 1-3, wherein the dry fissile material comprises uranium nitride (UN).

Clause 9—The method of any one of clauses 2, 3 or 8, wherein the dry process comprises reacting a carbide of uranium.

Clause 10—The method of any one of clauses 1-9, wherein forming the particle from the dry fissile material comprises forming a bead from the dry fissile material with a pelletizing process.

Clause 11—The method of clause 10, wherein the pelletizing process is a dry process.

Clause 12—The method of any one of clauses 10 or 11, wherein the pelletizing process comprises progressive pelletization.

Clause 13—The method of any one of clauses 10-12, further comprising tumbling the bead to produce the particle.

Clause 14—The method of any one of clauses 10-13, wherein the bead comprises a central portion and an outer portion extending from the central portion.

Clause 15—The method of clause 14, further comprising removing the outer portion to produce the particle.

Clause 16—The method of any one of clauses 14 or 15, further comprising recycling dry fissile material of the outer portion.

Clause 17—The method of any one of clauses 1-16, wherein thermally processing the particle comprises sintering the particle to a final density.

Clause 18—A fuel particle comprising the fuel kernel of any one of clauses 1-17.

Clause 19—A press system for dry fissile material. The press system comprises first tooling and second tooling. The first tooling comprises a first forming surface and the second tooling comprises a second forming surface. The first tooling and the second tooling are configured to transition the first forming surface and the second forming surface from a first configuration for receiving an amount of dry fissile material for forming a bead between the first forming surface and the second forming surface, the bead having dimensions suitable for forming a fuel kernel, and a second configuration that yields the bead.

Clause 20—The press system of clause 19, wherein the first tooling is a die and the second tooling comprises at least one of a die or a punch.

Clause 21—The press system of any one of clauses 18 or 19, wherein the first tooling and the second tooling are aligned with a pressing axis.

Various features and characteristics are described in this specification to provide an understanding of the composition, structure, production, function, and/or operation of the disclosure, which includes the disclosed methods and systems. It is understood that the various features and characteristics of the disclosure described in this specification can be combined in any suitable manner, regardless of whether such features and characteristics are expressly described in combination in this specification. The Inventors and the Applicant expressly intend such combinations of features and characteristics to be included within the scope of the disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the disclosure as defined in the appended claims.

What is claimed is:

1. A method for producing a fuel kernel, comprising:
producing a dry fissile material comprising enriched uranium;
forming a particle from the dry fissile material, the particle having a diameter of about 1 millimeter or less; and
thermally processing the particle to produce the fuel kernel.

2. The method of claim 1, further comprising preparing the dry fissile material with a dry process.

3. The method of claim 2, wherein the dry fissile material comprises uranium oxycarbide (UCO).

4. The method of claim 3, wherein the dry process comprises reacting uranyl fluoride (UO₂F₂) with a hydrocarbon compound to produce the UCO.

5. The method of claim 4, wherein the hydrocarbon compound comprises a volatile hydrocarbon.

6. The method of claim 4, wherein the hydrocarbon compound comprises methane.

7. The method of claim 4, wherein the dry process comprises reacting uranium hexafluoride with steam to produce the UO₂F₂.

8. The method of claim 2, wherein the dry fissile material comprises uranium nitride (UN).

9. The method of claim 2, wherein the dry process comprises reacting a carbide of uranium.

10. The method of claim 1, wherein forming the particle from the dry fissile material comprises forming a bead from the dry fissile material with a pelletizing process.

11. The method of claim 10, wherein the pelletizing process is a dry process.

12. The method of claim 10, wherein the pelletizing process comprises progressive pelletization.

13. The method of claim 10, further comprising tumbling the bead to produce the particle.

14. The method of claim 10, wherein the bead comprises a central portion and an outer portion extending from the central portion.

15. The method of claim 14, further comprising removing the outer portion to produce the particle.

16. The method of claim 15, further comprising recycling dry fissile material of the outer portion.

17. The method of claim 1, wherein thermally processing the particle comprises sintering the particle to a final density.

18. A fuel particle comprising the fuel kernel of claim 1.

19. A press system for dry fissile material, comprising:
a first tooling comprising a first forming surface; and
a second tooling comprising a second forming surface, wherein the first tooling and the second tooling are configured to transition the first forming surface and the second forming surface from a first configuration for receiving an amount of dry fissile material for forming a bead between the first forming surface and the second forming surface, the bead having dimensions suitable for forming a fuel kernel, and a second configuration that yields the bead.

20. The press system of claim 19, wherein the first tooling is a die and the second tooling comprises at least one of a die or a punch.
